(19) United States
(12) Patent Application Publication
(10) Pub. No.: US 2025/0371866 A1
(43) Pub. Date: Dec. 4, 2025

(54) PLANT RECOGNITION METHOD, ELECTRONIC DEVICE, NON-TRANSITORY STORAGE MEDIUM, AND COMPUTER PROGRAM PRODUCT

(71) Applicant: Hangzhou Ruisheng Software Co., Ltd., Zhejiang (CN)

(72) Inventors: Qingsong Xu, Zhejiang (CN); Tao He, Zhejiang (CN)

(73) Assignee: Hangzhou Ruisheng Software Co., Ltd., Zhejiang (CN)

(21) Appl. No.: 19/213,953

(22) Filed: May 20, 2025

(30) Foreign Application Priority Data
May 31, 2024 (CN) 202410702506.0

(51) Int. Cl. G06V 20/10; G06F 16/3329; G06V 10/44; G06V 10/82

(52) U.S. Cl. CPC G06V 20/188; G06F 16/33295; G06V 10/454; G06V 10/82

(57) ABSTRACT

A plant recognition method and related devices. The plant recognition method includes: obtaining a plant image and question text about recognizing the plant in the plant image; inputting the plant image and the question text to a plant recognition model, the plant recognition model includes a first visual model and a multimodal large language model, the first visual model is configured to receive the plant image to extract first image features of the plant image, the multimodal large language model is configured to receive the first image features and the question text to recognize the plant in the plant image, the plant recognition model is trained with multimodal data, the multimodal data includes plant images, questions about recognizing plants in the plant images, and answers to the questions; and outputting answer text provided by the plant recognition model about recognizing the plant in the plant image.

### CROSS-REFERENCE TO RELATED APPLICATION

This application claims the priority benefit of China application serial no. 202410702506.0, filed on May 31, 2024. The entirety of the above-mentioned patent application is hereby incorporated by reference herein and made a part of this specification.

### BACKGROUND

### Technical Field

The present disclosure relates to the field of information processing technology, and more specifically, relates to a plant recognition method and devices, an electronic device, a non-transitory storage medium and a computer program product.

### Description of Related Art

A multimodal large language model is a large neural network model that combines multiple different modalities of data such as text and images. This model may not only process text information, but may also simultaneously process other types of data, such as images, audio, etc. By simultaneously learning the associations between multimodal data, multimodal large language models is able to more comprehensively understand and express information. Multimodal large language models are commonly applied in various fields, such as natural language processing, computer vision, speech recognition, etc.

### SUMMARY

A brief overview of the present disclosure is provided below to provide a basic understanding of some aspects of the disclosure. However, it should be understood that this overview is not an exhaustive overview of the disclosure. It is not intended to identify key or critical elements of the disclosure, nor is it intended to limit the scope of the disclosure. Its purpose is merely to present some concepts of the disclosure in a simplified form as a prelude to the more detailed description presented later.

According to an aspect of the present disclosure, there is provided a plant recognition method, including: obtaining a plant image and question text about recognizing the plant in the plant image; inputting the plant image and the question text to a plant recognition model, the plant recognition model including a first visual model and a multimodal large language model, the first visual model being configured to receive the plant image to extract first image features of the plant image, the multimodal large language model being configured to receive the first image features and the question text to recognize the plant in the plant image, the plant recognition model being trained with multimodal data, the multimodal data including plant images, questions about recognizing plants in the plant images, and answers to the questions; and outputting answer text provided by the plant recognition model about recognizing the plant in the plant image.

In some embodiments, the plant recognition model further includes a second visual model different from the first visual model. The second visual model is configured to receive the plant image to extract second image features of the plant image. The multimodal large language model is configured to receive the first image features, the second image features and the question text to recognize the plant in the plant image.

In some embodiments, the first visual model is a convolutional neural network transformer model. The convolutional neural network transformer model is trained with plant image-text pairs through contrastive learning.

In some embodiments, the convolutional neural network transformer model is first separately pre-trained with plant image-text pairs through contrastive learning, and then jointly trained with the multimodal large language model using the multimodal data.

In some embodiments, the training set of the convolutional neural network transformer model includes plant images with one or more resolutions and label text with one or more granularities.

In some embodiments, during the training process of the convolutional neural network transformer model, one or more labels from the label text including multiple labels are randomly selected for extracting the text features of the label text.

In some embodiments, the obtained question text includes question text about recognizing the type of plant in the plant image. The multimodal data includes plant images, questions inquiring about the type of plant in the plant image, and answers indicating the type of plant in the plant image. The plant image-text pairs include at least one of a pair of plant image and plant Latin name, and a pair of plant image and plant feature label collection.

In some embodiments, the obtained question text includes question text about recognizing the symptom of the plant in the plant image. The multimodal data includes plant images, questions inquiring about the symptom of the plant in the plant image, and answers indicating the symptom of the plant in the plant image. The plant image-text pairs include at least one of a pair of plant image and plant symptom name, and a pair of plant image and symptom feature label set.

In some embodiments, the plant recognition method further includes: in response to the plant recognition model being unable to provide answer text about recognizing the plant in the plant image, outputting an interactive question about recognizing the plant in the plant image; obtaining a reply to the interactive question, and: in response to the reply including a reply image, providing image features extracted from the reply image using the first visual model to the multimodal large language model, and/or in response to the reply including reply text, providing the reply text to the multimodal large language model; and outputting new answer text provided by the plant recognition model about recognizing the plant in the plant image.

In some embodiments, the plant recognition method further includes: in response to the plant recognition model being unable to provide answer text about recognizing the plant in the plant image, outputting an interactive question about recognizing the plant in the plant image; obtaining a reply to the interactive question, and: in response to the reply including a reply image, providing image features extracted from the reply image using the first visual model and the second visual model respectively to the multimodal large language model, and/or in response to the reply including reply text, providing the reply text to the multimodal large language model; and outputting new answer text provided by the plant recognition model about recognizing the plant in the plant image.

In some embodiments, the obtained question text includes question text about recognizing the type of plant in the plant image. The interactive question includes one or more of: a request for a close-up image of one or more of feature parts of the plant, the capture time of the plant image, and the capture location of the plant image.

In some embodiments, the obtained question text includes question text about recognizing a symptom of the plant in the plant image. The interactive question includes one or more of: a request for a close-up image of one or more of infected parts of the plant, the capture time of the plant image, the capture location of the plant image, and details of plant care.

In some embodiments, the answer text includes the symptom of the plant, and the answer text further includes one or more of the cause of the symptom, the method for treating the symptom, and recommendations for plant care.

In some embodiments, the plant recognition model is also trained with second multimodal data. The second multimodal data includes an image, a question inquiring about the location of an object in the image, and an answer to the question.

In some embodiments, after inputting the plant image and the question text to the plant recognition model, the plant recognition model is further configured to: generate, by the multimodal large language model based on the plant image and the question text, a question inquiring about the location of the object in the plant image, and generate an answer about the location of the object in the plant image based on the plant image and the generated question; crop a local image of the region where the object is located from the plant image according to the location of the object in the plant image; receive, by the first visual model, the local image to extract third image features; receive, by the multimodal large language model, the first image features, the third image features and the question text to recognize the plant in the plant image.

In some embodiments, the plant recognition model is also trained with second multimodal data. The second multimodal data includes an image, a question inquiring about a location of an object in the image and an answer to the question. After inputting the plant image and the question text into the plant recognition model, the plant recognition model is configured to: generate, by the multimodal large language model based on the plant image and the question text, a question inquiring about the location of an object in the plant image, and generate an answer about the location of the object in the plant image based on the plant image and the generated question; crop a local image of the region where the object is located from the plant image according to the location of the object in the plant image; receive, by the first visual model, the local image to extract the third image features; receive, by the second visual model, the local image to extract fourth image features; receive, by the multimodal large language model, the first image features, the second image features, the third image features, the fourth image features and the question text to recognize the plant in the plant image.

In some embodiments, the local image is magnified before being received by the visual model.

In some embodiments, the object includes a plant, or one or more feature parts of a plant, or one or more infected parts of a plant.

In some embodiments, the second visual model is a multimodal contrastive language-image pretraining (CLIP) model.

In some embodiments, the plant recognition method further includes: in response to the plant recognition model being unable to provide answer text about recognizing the plant in the plant image, accessing an external plant knowledge base to obtain additional information about the plant image and the question text, and: in response to the additional information including additional images, providing image features extracted from the additional images using the first visual model to the multimodal large language model, and/or in response to the additional information including additional text, providing the additional text to the multimodal large language model; and outputting new answer text provided by the plant recognition model about recognizing the plant in the plant image.

In some embodiments, the plant recognition method further includes: in response to the plant recognition model being unable to provide answer text about recognizing the plant in the plant image, accessing an external plant knowledge base to obtain additional information about the plant image and the question text, and: in response to the additional information including additional images, providing image features extracted from the additional images using the first visual model and the second visual model respectively to the multimodal large language model, and/or in response to the additional information including additional text, providing the additional text to the multimodal large language model; and outputting new answer text provided by the plant recognition model about recognizing the plant in the plant image.

According to another aspect of the present disclosure, provided is an electronic device, including: one or more processors; and a memory storing computer executable instructions, wherein the computer executable instructions, when executed by the one or more processors, enable the one or more processors to execute the plant recognition method described in any embodiment of the aforementioned aspect of the present disclosure.

According to another aspect of the present disclosure, provided is a non-transitory storage medium storing computer executable instructions, wherein the computer executable instructions, when executed by a computer, enable the computer to execute the plant recognition method described in any embodiment of the aforementioned aspect of the present disclosure.

According to another aspect of the present disclosure, provided is a computer program product, the computer program product including instructions, the instructions, when executed by a processor, implement the plant recognition method described in any embodiment of the aforementioned aspect of the present disclosure.

### BRIEF DESCRIPTION OF THE DRAWINGS

The foregoing and other features and advantages of the present disclosure will become apparent from the following description of the embodiments of the present disclosure in conjunction with the accompanying drawings. The accompanying drawings are incorporated herein and form a part of the specification, and are further used to explain the principles of the present disclosure and enable those skilled in the art to make and use the present disclosure.

FIG. 1 is a flowchart of a plant recognition method according to some embodiments of the present disclosure.

FIG. 2A and FIG. 2B are schematic block diagrams of a plant recognition model according to some embodiments of the present disclosure.

FIG. 3A and FIG. 3B illustrate example training data for training a first visual model of a plant recognition model according to some embodiments of the present disclosure.

FIG. 4 and FIG. 5 are schematic diagrams of example user interfaces applying plant recognition methods according to some embodiments of the present disclosure.

FIG. 6 is a schematic block diagram of an electronic device according to some embodiments of the present disclosure.

FIG. 7 is a schematic block diagram of a computer system on which embodiments of the present disclosure may be implemented.

Note that in the following description of the embodiments, the same reference numerals are sometimes used in different drawings to indicate the same parts or parts with the same function, and repeated descriptions are omitted. In some cases, similar numerals and letters are used to indicate similar items, so once an item is defined in one drawing, no further discussion of it is needed in subsequent drawings.

For ease of understanding, the positions, dimensions, and ranges of various structures shown in the drawings, etc. may not represent the actual positions, dimensions, and ranges. Therefore, the present disclosure is not limited to the positions, dimensions, and ranges disclosed in the drawings, etc.

### DESCRIPTION OF THE EMBODIMENTS

The following will describe various exemplary embodiments of the present disclosure in detail with reference to the accompanying drawings. It should be noted that: unless otherwise specifically stated, the relative arrangement, numerical expressions and values of the components and steps set forth in these embodiments do not limit the scope of the present disclosure.

The following description of at least one exemplary embodiment is actually only illustrative, and in no way serves as any limitation on this disclosure and its application or use. That is to say, the structures and methods in this document are shown in an exemplary manner to explain different embodiments of the structures and methods in this disclosure. However, those skilled in the art will understand that they merely illustrate exemplary ways that may be used to implement the disclosure, rather than exhaustive ways. Furthermore, the drawings need not be drawn to scale, and some features may be enlarged to show details of specific components.

In addition, for technologies, methods, and devices already known to ordinary skilled persons in the related field, detailed discussions may not be provided, but in appropriate circumstances, said technologies, methods, and devices should be considered as part of the specification.

In all examples shown and discussed herein, any specific values should be interpreted as merely exemplary, and not as limitations. Therefore, other examples of exemplary embodiments may have different values.

The present disclosure in one aspect provides a plant recognition method, which utilizes a plant recognition model combining a visual model and a multimodal large language model, may automatically process plant images and related questions to provide answers. The plant recognition method according to the present disclosure will be described in detail in conjunction with the accompanying drawings. It should be understood that the actual method may include other additional steps, but to avoid obscuring the key points of the present disclosure, these other additional steps are not discussed and are not shown in the drawings.

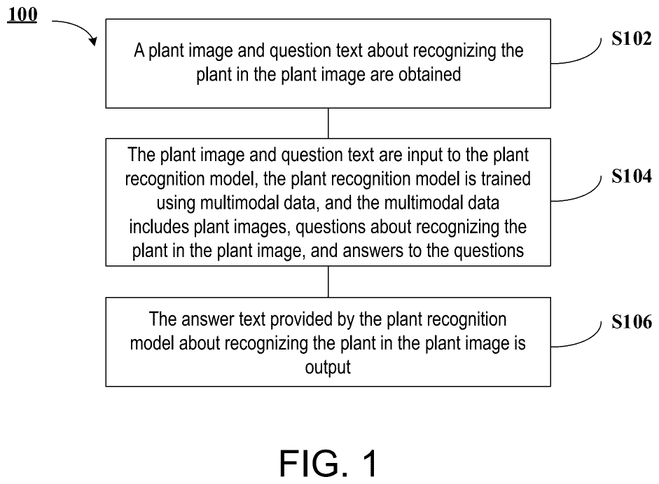

FIG. 1 shows a plant recognition method 100 (hereinafter referred to as method 100) according to some embodiments of the present disclosure. As shown in FIG. 1, the method 100 includes:

In step S102, a plant image and question text about recognizing the plant in the plant image are obtained, wherein the present disclosure may automatically capture an image through a set camera device. The camera device may be arranged at multiple positions and angles, or may be a camera device that moves along a rail. In other words, the camera device of the present application may obtain photographs of the plant and the plant growth environment in real time, and input the plant image to the processor. The question about the plant in the plant image may be plant information.

In another embodiment, the present disclosure may simultaneously configure a capturing device (for example, a camera, a video camera) and sensors, thereby obtaining plant growth environment information (including illumination environment information, humidity environment information, air environment information, temperature environment information, soil moisture information, soil particle information, and soil health information of the plant growth environment, etc.) of the plant in real time. Furthermore, the sensors or the capturing device may obtain user watering behavior information, as well as geographic location information of where the plant is located. The capturing device combined with multiple sensors may also model the environment to which the plant belongs, such as determining whether the plant is indoors or outdoors, whether the plant is grown in a garden, a botanical garden, a greenhouse, or wilderness, etc. Thus, the present disclosure may input the aforementioned plant growth environment information, user watering behavior information, and geographic location information as plant information into the processor or server.

In another embodiment, one or more camera devices and multiple different sensors of the present disclosure may be connected to the server of the present disclosure to process the obtained information, that is to say, the present disclosure may receive data transmitted by the camera devices and sensors through the server, thereby executing the steps of this method. In step S104, the plant image and question text are input to the plant recognition model, the plant recognition model is trained using multimodal data, and the multimodal data includes plant images, questions about recognizing the plant in the plant image, and answers to the questions.

In step S106, the answer text provided by the plant recognition model about recognizing the plant in the plant image is output.

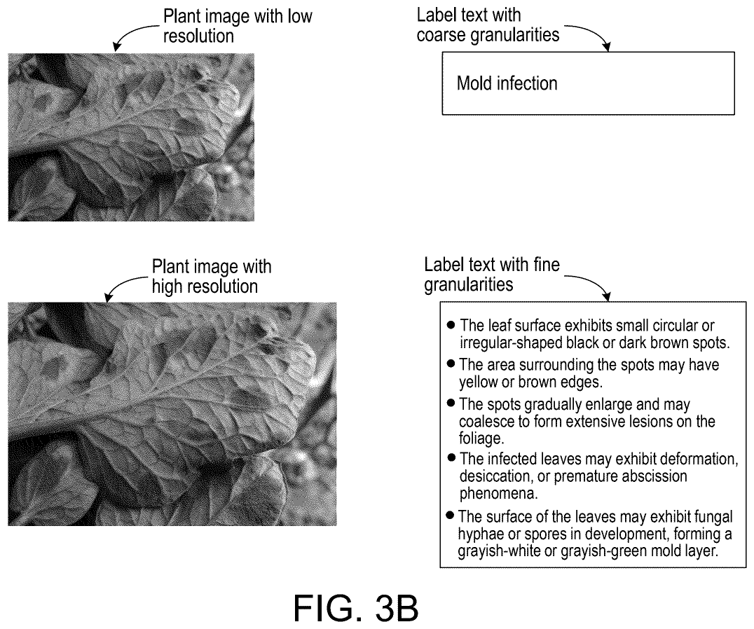

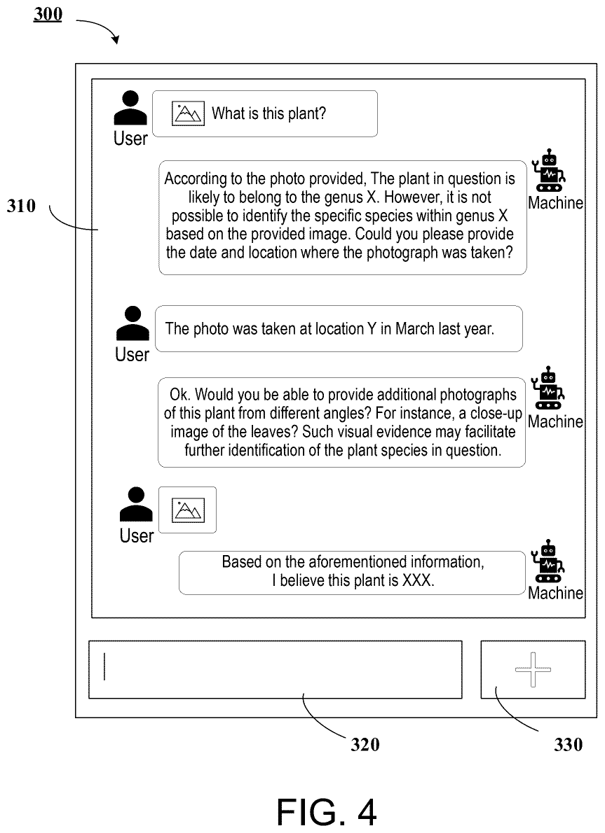

Specifically, recognizing plants in plant images may, for example, include recognizing the type of plants in plant images and/or symptoms, etc., correspondingly, the obtained question text may include question text about recognizing the type and/or symptoms, etc. of plants in plant images. As a non-limiting example, a user interface 300 as shown in FIG. 4 and FIG. 5 may be provided. The user interface 300 includes a dialog box 310, a text input box 320 and an image add button 330, where the image add button 330 is used for receiving plant images while the text input box 320 is used for receiving question text.

For recognizing the type of plant in plant images, the multimodal data used for training plant recognition models may include plant images, questions inquiring about the type of plant in the plant image, answers indicating the type of plant in the plant image, for example, {<plant image.jpg>, “What is this plant”, “This plant is a Ficus deltoidea”}. For recognizing the symptom of plant in plant images, the multimodal data used for training plant recognition models may include plant images, questions inquiring about the symptom of plant in the plant image, answers indicating the symptom of plant in the plant image, for example, {<plant image.jpg>, “What happens to the plant”, “This plant has leaf mold”}.

In the multimodal data used for training plant recognition models, plant images and questions may serve as training samples, while the answers to the questions may serve as sample labels. During the training process, the plant recognition model learns how to understand the relationship between images and text, as well as how to generate related answers. Through joint training on different modal data such as images and text, the plant recognition model may learn the corresponding relationship between different modalities, thereby realizing cross-modal information expression and reasoning capabilities. Through training data specific to the plant recognition domain, plant recognition capabilities are injected into the model.

Specifically, after the server or processor processes and analyses various types of information (such as plant images and data received/collected by sensors), analysis is performed by the plant recognition model, thereby generating answer text for the plant. The answer text may include care needed for the plant, or data for executing treatment operations for plant symptoms. Moreover, the server or processor of this disclosure implements corresponding care methods in the answer text through various configured care devices. The various care devices included in this disclosure may be, for example, automatic sprinkler devices for watering or spraying pesticides, ventilation devices, supplementary lighting devices, automatic soil-turning devices, automatic pruning devices, etc.

The installation position and quantity of camera devices, sensors, care devices, and symptom treatment devices may be adjusted according to different plants and different environments. In this way, by executing the method and device of the present disclosure, after obtaining preliminary original environmental information through the camera device, installation suggestions and guidance information may be provided through the device of the present disclosure. The guidance information may be instruction related to plant care. In other words, the plant diagnosis method and maintenance system of the present disclosure may include a processor, a server, a camera device, sensors, care devices, or symptom treatment devices. In an embodiment, the camera device and multiple different sensors are connected to the server to process the obtained information. After processing and analyzing various types of information, the server performs the required maintenance or symptom treatment operations through the set up various care devices.

The answer text of the present disclosure may include diagnostic results or maintenance methods. For example, the processor or server of the electronic device of the present disclosure may control automatic sprinkler devices to water or spray pesticides based on the diagnostic results or maintenance methods. Alternatively, the electronic device may control transport devices (such as transport robots, etc.) to move plants to designated locations based on the diagnostic results. Alternatively, the electronic device may control ventilation devices to turn on fans to enhance exhaust, or open vents, etc. based on the diagnostic results. Alternatively, the electronic device may control light supplementation devices to increase or decrease illumination based on the diagnostic results. Alternatively, the electronic device may control automatic soil-turning devices to move to designated locations to perform soil-turning actions based on the diagnostic results. Alternatively, the electronic device may control automatic pruning devices to trim specified parts of plants based on the diagnostic results.

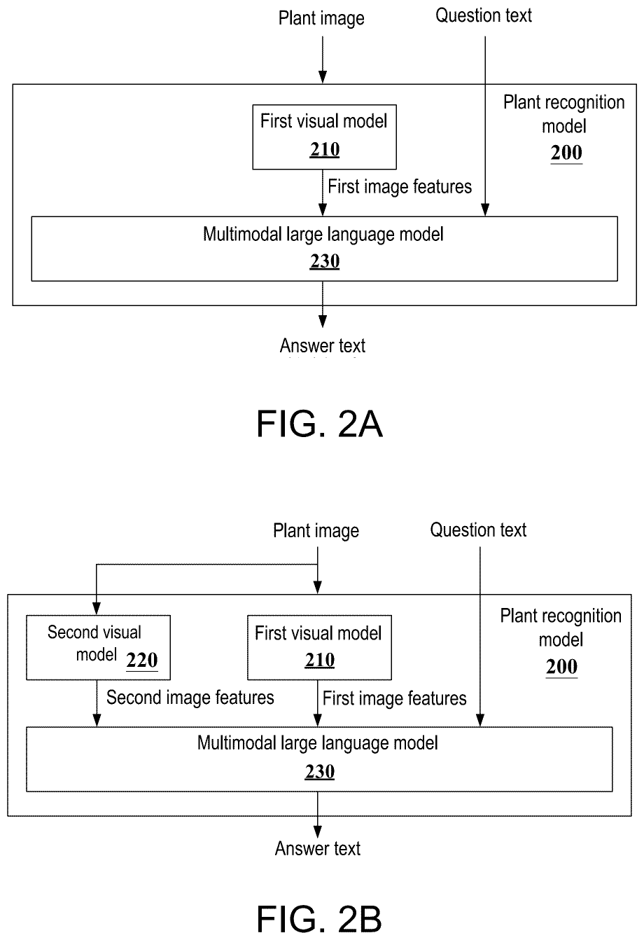

FIG. 2A illustrates a plant recognition model 200 according to some embodiments of the present disclosure. As shown in FIG. 2A, the plant recognition model 200 includes a first visual model 210 and a multimodal large language model 230. The first visual model 210 is configured to receive a plant image to extract first image features of the plant image. The multimodal large language model 230 is configured to receive the first image features and question text to recognize the plant in the plant image, thereby outputting answer text about recognizing the plant in the plant image.

The visual capability of the multimodal large language model 230 may primarily rely on the first visual model 210, especially the image features extracted by the first visual model 210. Therefore, the expressive capability of the image features of the first visual model 210 will directly affect the performance of the multimodal large language model in plant recognition visual tasks.

The first visual model 210 may be based on various suitable neural network architectures, such as ResNet, DenseNet, etc. In some embodiments, the first visual model 210 may be a convolutional neural network (CNN) transformer model, for example but not limited to ConvNextmodel. To improve the expressive ability of such visual models in the field of plant recognition, the visual models may be trained using plant image-text pairs through contrastive learning. For example, the convolutional neural network transformer model may first be pre-trained separately using plant image-text pairs through contrastive learning, and then jointly trained with the multimodal large language model 230 using multimodal data, which is beneficial for improving the overall performance of the model. Of course, the convolutional neural network transformer model may also be separately pre-trained, and then when training the plant recognition model using multimodal data, the parameters of the convolutional neural network transformer model may be fixed while only updating the parameters of the multimodal large language model, which may accelerate the training speed and reduce the computational and storage resources consumed by training.

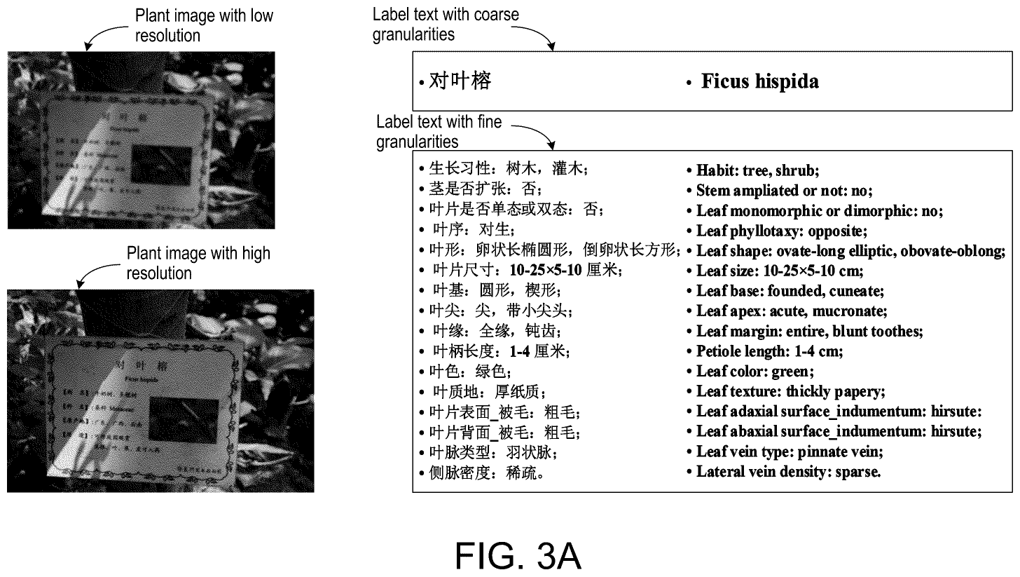

Exemplary, the training set of the convolutional neural network transformer model may include plant images with one or more resolutions and label text with one or more granularities. For non-limiting illustrative purposes, FIG. 3A and FIG. 3B show example training data for training the convolutional neural network transformer model. As shown in FIG. 3A, in order to recognize the type of plant in the plant image, plant images with two different resolutions and label text with two different granularities are provided, where the coarse-grained label text is the type of plant (for example, indicated by the Latin name of the plant), and the fine-grained label text is the plant feature label (for example, the morphology (for example, shape, size, color, texture, location, etc.) of feature parts of the plant such as leaves, stems, flowers, fruits, etc.). As shown in FIG. 3B, in order to recognize the symptom of the plant in the plant image, plant images with two different resolutions and label text with two different granularities are provided, where the coarse-grained label text is the symptom name of the plant, and the fine-grained label text is the symptom feature label (for example, various specific manifestations of the symptom, etc.). By including label text of different granularities in the training set, it is possible to help the model learn semantic information at more levels. The finer the granularity, the more likely it is to obtain stronger vision feature expression capabilities. By including plant images of different resolutions in the training set, the robustness of the model may be enhanced. Additionally, before plant images of different resolutions are input to the model, they may be interpolated to convert to a uniform resolution for processing by the model. Although FIG. 3A and FIG. 3B only exemplarily show plant images with two different resolutions and label text with two different granularities, this is not limiting, and any types of plant images with different resolutions and label text with any types granularities may be provided, such as providing plant images with one resolution and label text with two or more granularities, etc. Additionally, the label text in the training set may be based on one or more languages. For example, the label text in FIG. 3A may be in both Chinese and English, which also helps to enhance the robustness of the model.

Exemplarily, in the training process of a convolutional neural network transformer model, one or more labels from a label text including multiple labels maybe randomly selected for extracting the text features of the label text, which may enhance robustness of the model. For example, in FIG. 3A, the fine-grained label text includes 16 labels, in the training process of the convolutional neural network transformer model, it is possible to randomly select one or more labels from these 16 labels for extracting the text features of the fine-grained label text.

Samples for training convolutional neural network transformer models may take the form of plant image-text pairs. For example, in order to recognize the type of plant in plant images, plant image-text pairs may include at least one of: a pair of plant images and plant Latin names, or a pair of plant images and plant feature label collection. In order to recognize plant symptoms in plant images, plant image-text pairs may include at least one of: a pair of plant images and plant symptom names, or a pair of plant images and symptom feature label collection. For non-limiting explanatory purposes, FIG. 3A and FIG. 3B each show training data that may constitute four plant image-text pairs.

The training process of contrastive learning based on plant image-text pairs for convolutional neural network transformer model is exemplified as follows. For plant image-text pairs input to the convolutional neural network transformer model, the image features are extracted by its image encoder, and the text features are extracted by its text encoder. Assuming a training batch includes N plant image-text pairs, the image encoder will extract N image features, and the text encoder will also extract N text features. The N image features and N text features are combined in pairs, resulting in N² samples. Specifically, for each image feature, there are 1 positive sample and (N−1) negative samples. For each text feature, there are 1 positive sample and (N−1) negative samples. In total, there are N positive samples and (N²−N) negative samples. The training objective may be to maximize the similarity of the N positive samples (for example, the cosine similarity between text features and image features may be calculated directly). The training process is equivalent to a multi-classification task, and cross-entropy loss may be calculated.

Through contrastive learning, the expression capability of visual features in convolutional neural network transformer models may be enhanced, thereby improving the performance of multimodal large language models on vision tasks, and ultimately enhancing the plant recognition capability of the entire plant recognition model.

In some embodiments, for example, referring to FIG. 2B, the plant recognition model 200 may also include a second visual model 220 different from the first visual model 210. The second visual model 220 is configured to receive plant images to extract second image features of the plant images. Thereby, the multimodal large language model 230 may be configured to receive the first image features, the second image features, and the question text to recognize the plant in the plant image, thereby outputting answer text about recognizing the plant in the plant image. For example, the second visual model 220 maybe a multimodal contrastive language-image pretraining (CLIP) model. The CLIP model is a deep learning model designed to realize interaction between natural language processing and computer vision. The second visual model 220 may directly adopt a pre-trained CLIP model, without necessarily requiring specific training with data from the field of plant recognition. By adding the second visual model 220, the generalization of the plant recognition model 200 may be enhanced, which is also beneficial for improving the plant recognition performance of the plant recognition model 200.

In some embodiments, the method 100 may also include: in response to the plant recognition model being unable to provide answer text about recognizing the plant in the plant image, outputting an interactive question about recognizing the plant in the plant image; obtaining a reply to the interactive question, and: in response to the reply including a reply image, providing image features extracted from the reply image using the first visual model (and the second visual model, if any) to the multimodal large language model, and/or in response to the reply including reply text, providing the reply text to the multimodal large language model; and outputting new answer text provided by the plant recognition model about recognizing the plant in the plant image.

For example, when a plant recognition model, especially a multimodal large language model, experiences issues such as failure to converge, insufficient confidence in output results, or insufficient granularity of output results, it may be considered that the plant recognition model cannot provide answer text about recognizing plants in plant images. This may be because the presence of many plants in the plant image and not knowing which plant is being inquired about, plants in the plant image being too small to distinguish, or the question text being too vague, among other reasons. For such situations, information (especially highly distinctive information) may be gathered through interactive questions to generate accurate and reliable answers. For instance, assuming the obtained question text includes question text about identifying the type of plant in a plant image, then the interactive questions may include one or more of: a request for a close-up image of one or more feature parts of the plant, the capture time of the plant image, and the capture location of the plant image. The answer text may include the type of plant, for example, specifically the Latin name of the plant. Assuming the obtained question text includes question text about identifying a symptom of a plant in a plant image, then the interactive questions may include one or more of: a request for a close-up image of one or more infected parts of the plant, the capture time of the plant image, the capture location of the plant image, and details of plant care. The answer text may include the symptom of the plant, and for example, may also include one or more of the cause of the symptom, methods for treating the symptom, and recommendations for plant care.

Further, interactive question chains may be designed, and then interactive questions are output sequentially along the interactive question chain until the information obtained is sufficient to provide answer text about recognizing the plant in the plant image. For example, for a question about recognizing the type of plant in a plant image, it is possible to first inquire about the capture time of the plant image and the capture location of the plant image, and if the answer text still cannot be output, it is possible to further request close-up images of the feature parts of the plant.

For non-limiting explanatory purposes, for example referring to FIG. 4, a user provides a photograph of a plant and inquires what this plant is. According to the photograph provided by the user, since the plant can only be identified to belong to X genus but cannot be confirmed which species is the plant under the X genus, the user is requested to provide the time and location where the photograph was captured. After the user replies that the photograph was captured at location Y in March last year, because an accurate reliable answer still cannot be provided (for example, the specific species still cannot be identified), so the user is further requested to provide photographs of this plant from other angles, such as a close-up image of the leaves. In response to the new photographs provided by the user, it is found that photographs are sufficient for an accurate reliable answer to be provided, therefore the answer text is output to the user.

Additionally or alternatively, in some embodiments, the method 100 may also include: in response to the plant recognition model being unable to provide an answer text about recognizing the plant in the plant image, accessing an external plant knowledge base to obtain additional information about the plant image and the question text, and: in response to the additional information including additional images, providing the image features extracted from the additional images using the first visual model (and the second visual model, if any) to the multimodal large language model, and/or in response to the additional information including additional text, providing the additional text to the multimodal large language model; and outputting the new answer text provided by the plant recognition model about recognizing the plant in the plant image.

Through the above interaction, the model may, based on its original recognition ability, use prior knowledge, additional information and reasoning capability to realize improved recognition accuracy and reliability.

In addition, plant recognition tasks may only need to focus on a specific part in the image to complete recognition. For example, the leaves of some plants may be very distinctive, so that one can easily determine the type of plant just by looking at the leaves. When diagnosing symptoms for plants, one may only need to focus on the infected part to complete the diagnosis. However, limited by the resolution of image encoder of the model, these special parts sometimes cannot be captured by the model, which may affect recognition accuracy. Therefore, visual chain-of-thought technology may be further adopted to help the model search for special parts in the image, thus allowing the model to recognize by combining global information, key region information, and other information (for example, descriptions provided by the user, etc.).

In view of the foregoing, the object detection capability of multimodal large language models may be trained. In some embodiments, the plant recognition model is also used to train second multimodal data. The second multimodal data may include images, questions inquiring about the location of objects in the images, and answers to the questions. Similarly, in the second multimodal data used for training the plant recognition model, plant images and questions may serve as training samples, while the answers to the questions may serve as sample labels. During the training process, the plant recognition model learns how to understand the relationship between images and text, as well as how to generate related answers. Exemplarily, the object may include plants, or one or more feature parts of plants, or one or more infected parts of plants.

Based on the above, in some examples, after inputting the plant image and question text into the plant recognition model, the plant recognition model is further configured to: generate a question inquiring about the location of the object in the plant image by the multimodal large language model based on the plant image and question text, and generate an answer of the location of the object in the plant image based on the plant image and the generated question; crop a local image of the region where the object is located from the plant image according to the location of the object in the plant image; receive the local image by the first visual model to extract third image features; receive the first image features, the third image features, and the question text by the multimodal large language model to recognize the plant in the plant image. In some examples, if the plant recognition model includes a second visual model, the plant recognition model may be further configured to: receive the local image by the second visual model to extract fourth image features, receive the first image features, the second image features, the third image features, the fourth image features, and the question text by the multimodal large language model to recognize the plant in the plant image. For example, the local image is magnified (for example, through interpolation, etc.) to become clearer before being received by the visual model.

For non-limiting explanatory purposes, for example referring to FIG. 5, a user provides a photo of a plant and inquires what is happening with the plant that has problem A. According to the photo and question description provided by the user, the model asks itself “Where in the plant image does problem A appear” and then answers itself “The area in the plant image where problem A appears”, then “the area in the plant image where problem A appears” is cropped as a local image and magnified, and then processed together with the question text. After determining that the plant has problem A, the user is further requested to provide more information to help diagnose the cause of the disease, such as the location, frequency of watering and other maintenance operations. After the user responds that the plant is in location Y and watered 2-3 times per week, the answer is generated by combining all information.

In addition to incorporating visual chain-of-thought technology into multimodal large language models, visual chain-of-thought technology may also be applied by making plant recognition models to be equipped with means including object detection models. For example, special parts in images may be detected through object detection models, local images where special parts are located may be cropped (for example, according to detection boxes output by the object detection model). Additionally, for example, interpolation and other magnification operations may be performed on the cropped local images with the purpose of clarifying them, and then the local images are input into the visual model to extract image features for use by the multimodal large language model.

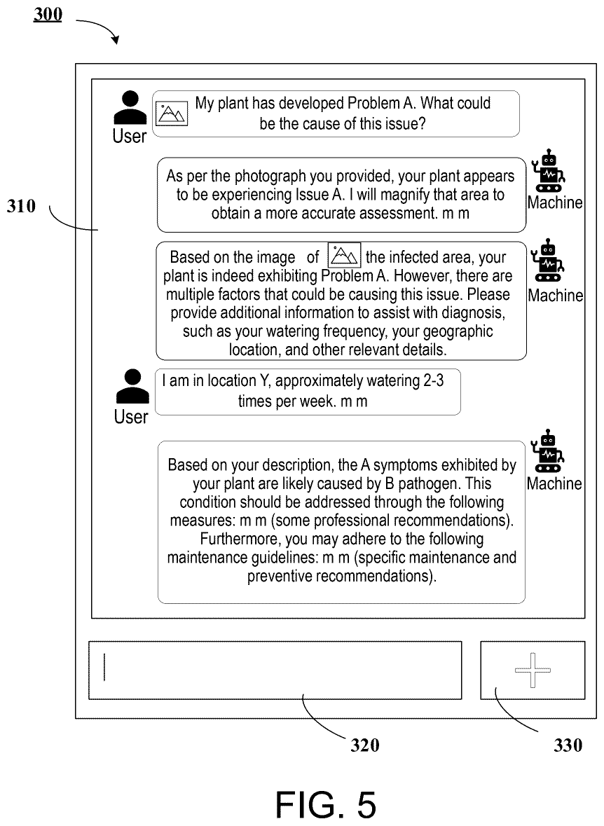

The present disclosure in another aspect also provides an electronic device. Referring to FIG. 6, which shows a schematic block diagram of an electronic device 600 according to some embodiments of the present disclosure. As shown in FIG. 6, the electronic device 600 includes (one or more) processor(s) 602 and a memory 604 storing computer executable instructions. The computer executable instructions, when executed by the (one or more) processor(s) 602, enable the (one or more) processor(s) 602 to execute the method described in any of the aforementioned embodiments of the present disclosure. The (one or more) processor(s) 602 may, for example, be a central processing unit (CPU) of the electronic device 600. The (one or more) processor(s) 602 may be any type of general-purpose processor, or may be a processor specially designed for plant recognition, such as an application-specific integrated circuit (“ASIC”). The memory 604 may include various computer-readable media accessible by the (one or more) processor(s) 602. In various embodiments, the memory 604 described herein may include volatile and non-volatile media, removable and non-removable media. For example, the memory 604 may include any combination of the following: random access memory (“RAM”), dynamic RAM (“DRAM”), static RAM (“SRAM”), read-only memory (“ROM”), flash memory, cache memory, and/or any other type of non-transitory computer-readable media. The memory 604 may store instructions that, when executed by the processor 602, enable the processor 602 to execute the method described in any of the aforementioned embodiments of the present disclosure. In some embodiments, the electronic device 600 may be implemented as a smartphone, smart camera, computer, etc.

The present disclosure also provides a non-transitory storage medium storing computer executable instructions, wherein the computer executable instructions, when executed by a computer, enable the computer to execute the method described in any of the aforementioned embodiments of the present disclosure.

The present disclosure also provides a computer program product, which may include instructions that, when executed by a processor, may implement the method described in any of the aforementioned embodiments of the present disclosure. The instructions may be any instruction set that will be executed directly by one or more processors, such as machine code, or any instruction set that will be executed indirectly, such as scripts. The instructions may be stored in object code format for direct processing by one or more processors, or stored in any other computer language, including scripts or collections of independent source code modules that are interpreted on demand or compiled in advance.

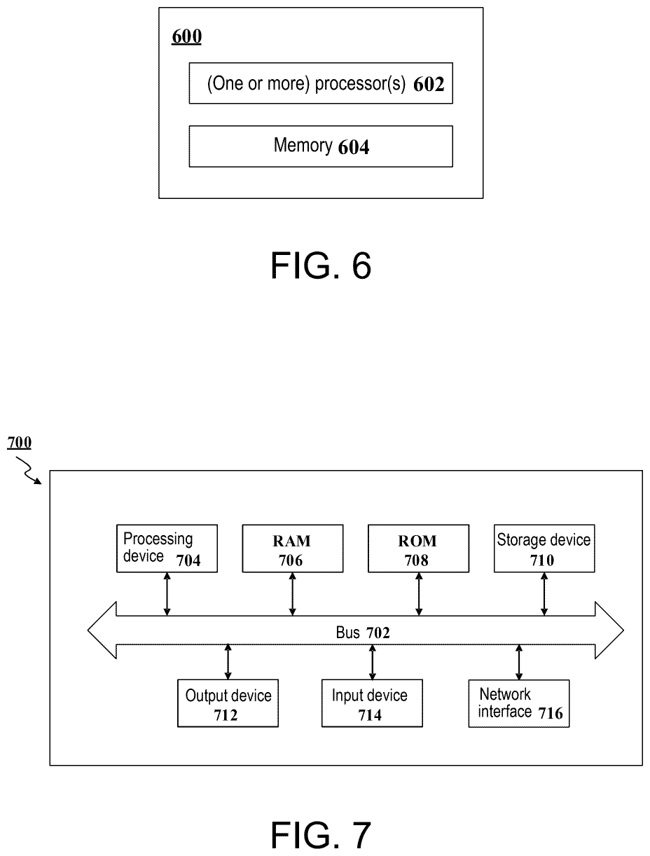

FIG. 7 shows a schematic block diagram of a computer system 700 on which embodiments of the present disclosure may be implemented. The computer system 700 includes a bus 702 or other communication mechanism for transmitting information, and a processing device 704 coupled with the bus 702 for processing information. The computer system 700 also includes a memory 706 coupled to the bus 702 for storing instructions to be executed by the processing device 704. The memory 706 may be a random access memory (RAM) or other dynamic storage device. The memory 706 may also be used for storing temporary variables or other intermediate information during execution of instructions by the processing device 704. The computer system 700 also includes a read-only memory (ROM) 708 or other static storage device coupled to the bus 702 for storing static information and instructions for the processing device 704. A storage device 710, such as a magnetic disk or optical disk, is provided and coupled to the bus 702 for storing information and instructions. The computer system 700 may be coupled to the output device 712 via the bus 702 for providing output to the user, the output device 712 may include, for example but not limited to, displays (such as cathode ray tube (CRT) or liquid crystal display (LCD)), speakers, etc. Input devices 714, such as keyboards, mice, microphones, etc., are coupled to the bus 702 for transmitting information and command selections to the processing device 704. The computer system 700 may execute embodiments of the present disclosure. Consistent with some implementations of the present disclosure, results are provided by the computer system 700 in response to the processing device 704 executing one or more sequences of one or more instructions contained in the memory 706. Such instructions may be read into the memory 706 from another computer-readable medium, such as storage device 710. Execution of the sequences of instructions contained in the memory 706 enables the processing device 704 to perform the methods described herein. Alternatively, hardwired circuitry may be used in place of or in combination with software instructions to implement the teachings. Thus, implementations of the present disclosure are not limited to any specific combination of hardware circuitry and software. In various embodiments, the computer system 700 may be connected to one or more other computer systems like computer system 700 across a network through a network interface 716 to form a networked system. The network may include a private network or a public network such as the Internet. In a networked system, one or more computer systems may store data and supply data to other computer systems. As used herein, the term “computer-readable medium” refers to any medium that participates in providing instructions to the processing device 704 for execution. Such medium may take many forms, including but not limited to, non-volatile media, volatile media, and transmission media. Non-volatile media includes, for example, optical or magnetic disks, such as storage device 710. Volatile media includes dynamic memory, such as memory 706. Transmission media includes coaxial cables, copper wire and fiber optics, including the wires that include the bus 702. Common forms of computer-readable media or computer program products include, for example, floppy disks, flexible disks, hard disks, magnetic tapes, or any other magnetic medium, CD-ROM, digital video disks (DVD), Blu-ray disks, any other optical medium, thumb drives, memory cards, RAM, PROM and EPROM, flash EPROM, any other memory chip or cartridge, or any other tangible medium from which a computer can read. Various forms of computer-readable media may be involved in carrying one or more sequences of one or more instructions to the processing device 704 for execution. For example, the instructions may initially be carried on a magnetic disk of a remote computer. The remote computer may load the instructions into its dynamic memory and send the instructions over a telephone line using a modem. A modem local to the computer system 700 may receive the data on the telephone line and use an infrared transmitter to convert the data to an infrared signal. An infrared detector coupled to the bus 702 may receive the data carried in the infrared signal and place the data on the bus 702. The bus 702 carries the data to the memory 706, from which the processing device 704 retrieves and executes the instructions. For example, the instructions received by the memory 706 may be stored on the storage device 710 before or after execution by the processing device 704.

The above describes one or more exemplary embodiments of the disclosure. Other embodiments are within the scope of the appended claims. In some cases, the actions or steps recorded in the claims may be executed in an order different from that in the embodiments and may still achieve the desired results. Additionally, the processes depicted in the drawings do not necessarily require the specific order or sequential order shown to achieve the desired results. In some embodiments, multi-tasking and parallel processing may also be possible or may be advantageous.

The systems, devices, modules or units elucidated in the above embodiments may be specifically realized by computer chips or entities, or may be realized by products with some functions. A typical implementation device is a server system. Certainly, this disclosure does not exclude that with the future development of computer technology, the computer implementing the functions of the above embodiments may be a personal computer, laptop, in-vehicle human-machine interaction device, cellular telephone, camera phone, smartphone, personal digital assistant, media player, game console, tablet computer, wearable device, or any combination thereof.

The term “include,” “contain,” or any other variants thereof are intended to cover non-exclusive inclusion, such that a process, a method, a product, or a device that includes a series of elements not only includes those elements, but also includes other elements not explicitly listed, or elements inherent to such process, method, product, or device. Without further restrictions, it does not exclude the presence of additional identical or equivalent elements in the process, method, product, or device that includes the stated elements. For example, if words such as “first,” “second,” etc. are used to indicate names, they do not represent any specific order.

For the convenience of description, the above device is described in terms of various modules according to their functions. Of course, when implementing one or more embodiments of this disclosure, the functions of each module may be realized in one or more software and/or hardware, or the modules that implement the same function may be realized by a combination of multiple sub-modules or sub-units. The device embodiments described above are merely illustrative, for example, the division of the units is merely a logical functional division, and there may be other division methods in actual implementation, for example, multiple units or components may be combined or integrated into another system, or some features may be ignored or not executed. Another point is that the coupling or direct coupling or communication connection between each other as displayed or discussed may be performed through some interfaces, devices or units, indirect coupling or communication connection, which may be in electrical, mechanical or other forms.

The present disclosure is described with reference to flowcharts and/or block diagrams of methods, devices (systems), and computer program products according to embodiments of the present disclosure. It should be understood that each process and/or block in the flowcharts and/or block diagrams, as well as combinations of processes and/or blocks in the flowcharts and/or block diagrams, may be implemented by computer program instructions. These computer program instructions may be provided to a processor of a general computer, special purpose computer, embedded processor, or other programmable data processing device to produce a machine, such that the instructions executed by the processor of the computer or other programmable data processing device generate a device for implementing the functions specified in one or more processes of the flowcharts and/or one or more blocks of the block diagrams.

These computer program instructions may also be stored in a computer-readable memory that can direct a computer or other programmable data processing device to work in a specific manner, such that the instructions stored in the computer-readable memory produce an article of manufacture including an instruction device. The instruction device implements the functions specified in one process or multiple processes of the flow chart and/or one block or multiple blocks of the block diagram. These computer program instructions may also be loaded onto a computer or other programmable data processing device, causing a series of operational steps to be executed on the computer or other programmable device to produce a computer-implemented process, thereby the instructions executed on the computer or other programmable device provide steps for implementing the functions specified in one process or multiple processes of the flow chart and/or one block or multiple blocks of the block diagram.

Those skilled in the art should understand that one or more embodiments of the present disclosure may take the form of entirely hardware embodiments, entirely software embodiments, or embodiments combining software and hardware aspects. Moreover, one or more embodiments of the present disclosure may take the form of a computer program product implemented on one or more computer-usable storage media (including but not limited to magnetic disk memory, CD-ROM, optical memory, etc.) containing computer-usable program code.

One or more embodiments of the present disclosure may be described in the general context of computer executable instructions executed by a computer, such as program modules. Generally, program modules include routines, programs, objects, components, data structures, etc. that perform particular tasks or implement particular abstract data types. One or more embodiments of the present disclosure may also be practiced in distributed computing environments where tasks are performed by remote processing devices that are connected through a communications network. In a distributed computing environment, program modules may be located in both local and remote computer storage media including memory devices.

The same or similar parts between various embodiments of this disclosure may refer to each other, with each embodiment focusing on explaining the differences from other embodiments. Especially, in terms device embodiments, since they are basically similar to method embodiments, the descriptions of device embodiments are relatively simple, and relevant parts can be referred to in the method embodiment descriptions. In the description of this disclosure, reference to terms such as “an embodiment,” “some embodiments,” “example,” “specific example,” or “some examples,” “exemplary,” etc., indicates that the specific features, structures, materials, or characteristics described in connection with the embodiment or example are included in at least one embodiment or example of this disclosure. In this disclosure, the illustrative expressions of the above terms are not necessarily directed to the same embodiment or example. Moreover, the described specific features, structures, materials, or characteristics may be combined in any suitable manner in one or more embodiments or examples. Furthermore, in non-contradictory situations, those skilled in the art may combine and integrate different embodiments or examples as well as features of different embodiments or examples described in this disclosure.

Additionally, when used in this disclosure, the terms “herein”, “above”, “below”, “following description”, “preceding description” and words of similar meaning should refer to the disclosure as a whole and not to any particular portion of the disclosure. Furthermore, unless otherwise clearly stated or understood from the context in which they are used, conditional language used herein, such as “may”, “could”, “for example”, “such as”, etc., is generally intended to convey that some embodiments include, while other embodiments do not include, some features, elements and/or states. Thus, such conditional language is not generally intended to imply that one or more embodiments necessarily require features, elements and/or states, or whether these features, elements and/or states are included or executed in any particular embodiment.

The above description is merely an embodiment of one or more embodiments of the present disclosure, and is not intended to limit the one or more embodiments of the present disclosure. For those skilled in the art, the one or more embodiments of the present disclosure may have various changes and variations. Any modifications, equivalent substitutions, improvements, etc., made within the spirit and principle of the present disclosure should be included within the scope of the claims.

What is claimed is:

1. A plant recognition method, comprising:
obtaining a plant images and question text about recognizing a plant in the plant images;
inputting the plant images and the question text to a plant recognition model, the plant recognition model comprising a first visual model and a multimodal large language model, the first visual model being configured to receive the plant images to extract first image features of the plant images, the multimodal large language model being configured to receive the first image features and the question text to recognize the plant in the plant images, the plant recognition model being trained with multimodal data, the multimodal data comprising plant images, questions about recognizing the plant in the plant images, and answers to the questions; and
outputting answer text provided by the plant recognition model about recognizing the plant in the plant images.

2. The plant recognition method according to claim 1, wherein the plant recognition model further comprises a second visual model different from the first visual model, the second visual model is configured to receive the plant images to extract second image features of the plant images, the multimodal large language model is configured to receive the first image features, the second image features and the question text to recognize the plant in the plant images.

3. The plant recognition method according to claim 1, wherein the first visual model is a convolutional neural network transformer model, the convolutional neural network transformer model is trained with plant image-text pairs through contrastive learning.

4. The plant recognition method according to claim 3, wherein the convolutional neural network transformer model is first separately pre-trained with the plant image-text pairs through the contrastive learning, and then jointly trained with the multimodal large language model using the multimodal data.

5. The plant recognition method according to claim 3, wherein a training set of the convolutional neural network transformer model comprises plant images with one or more resolutions and label text with one or more granularities.

6. The plant recognition method according to claim 5, wherein during a training process of the convolutional neural network transformer model, one or more labels from label text comprising a plurality of labels are randomly selected for extracting text features of the label text.

7. The plant recognition method according to claim 3, wherein the question text, which is obtained, comprises question text about recognizing a type of the plant in the plant images, the multimodal data comprises the plant images, questions inquiring about the type of the plant in the plant images, and answers indicating the type of the plant in the plant images, the plant image-text pairs comprise at least one of a pair of the plant images and plant Latin name, and a pair of the plant images and plant feature label collection.

8. The plant recognition method according to claim 3, wherein the question text, which is obtained, comprises question text about recognizing a symptom of the plant in the plant images, the multimodal data comprises the plant images, questions inquiring about the symptom of the plant in the plant images, and answers indicating the symptom of the plant in the plant images, the plant image-text pairs comprise at least one of a pair of the plant images and plant symptom name, and a pair of the plant images and symptom feature label set.

9. The plant recognition method according to claim 1, further comprising:
in response to the plant recognition model being unable to provide the answer text about recognizing the plant in the plant images, outputting an interactive question about recognizing the plant in the plant images;
obtaining a reply to the interactive question, and:
in response to the reply comprising a reply image, providing image features extracted from the reply image using the first visual model to the multimodal large language model, and/or
in response to the reply comprising reply text, providing the reply text to the multimodal large language model; and
outputting new answer text provided by the plant recognition model about recognizing the plant in the plant images.

10. The plant recognition method according to claim 2, further comprising:
in response to the plant recognition model being unable to provide the answer text about recognizing the plant in the plant images, outputting an interactive question about recognizing the plant in the plant images;
obtaining a reply to the interactive question, and:
in response to the reply comprising a reply image, providing image features extracted from the reply image using the first visual model and the second visual model respectively to the multimodal large language model, and/or
in response to the reply comprising reply text, providing the reply text to the multimodal large language model; and
outputting new answer text provided by the plant recognition model about recognizing the plant in the plant images.

11. The plant recognition method according to claim 9, wherein the question text, which is obtained, comprises question text about recognizing a type of the plant in the plant images, the interactive question comprises one or more of: a request for a close-up image of one or more of feature parts of the plant, a capture time of the plant images, and a capture location of the plant images.

12. The plant recognition method according to claim 9, wherein the question text, which is obtained, comprises question text about recognizing a symptom of the plant in the plant images, the interactive question comprises one or more of: a request for a close-up image of one or more of infected parts of the plant, a capture time of the plant images, a capture location of the plant images, and details of plant care.

13. The plant recognition method according to claim 12, wherein the answer text comprises the symptom of the plant, and the answer text further comprises one or more of a cause of the symptom, a method for treating the symptom, and recommendations for the plant care.

14. The plant recognition method according to claim 1, wherein the plant recognition model is further trained with second multimodal data, the second multimodal data comprises an image, a question inquiring about a location of an object in the image, and a corresponding answer.

15. The plant recognition method according to claim 14, wherein after inputting the plant images and the question text to the plant recognition model, the plant recognition model is further configured to:
generate, by the multimodal large language model based on the plant images and the question text, a question inquiring about a location of an object in the plant images, and generate an answer about the location of the object in the plant images based on the plant images and the question, which is generated;
crop a local image of a region where the object is located from the plant images according to the location of the object in the plant images;
receive, by the first visual model, the local image to extract third image features;
receive, by the multimodal large language model, the first image features, the third image features and the question text to recognize the plant in the plant images.

16. The plant recognition method according to claim 2, wherein the plant recognition model is further trained with second multimodal data, the second multimodal data comprises an image, a question inquiring about a location of an object in the image and a corresponding answer to the question, after inputting the plant images and the question text into the plant recognition model, the plant recognition model is configured to:
generate, by the multimodal large language model based on the plant images and the question text, a question inquiring about a location of an object in the plant images, and generate an answer about the location of the object in the plant images based on the plant images and the question, which is generated;
crop a local image of a region where the object is located from the plant images according to the location of the object in the plant images;
receive, by the first visual model, the local image to extract third image features;
receive, by the second visual model, the local image to extract fourth image features;
receive, by the multimodal large language model, the first image features, the second image features, the third image features, the fourth image features and the question text to recognize the plant in the plant images.

17. The plant recognition method according to claim 15, wherein the local image is magnified before being received by a visual model.

18. The plant recognition method according to claim 15, wherein the object comprises the plant, or one or more feature parts of the plant, or one or more infected parts of the plant.

19. The plant recognition method according to claim 2, wherein the second visual model is a multimodal contrastive language-image pretraining (CLIP) model.

20. The plant recognition method according to claim 1, further comprising:
in response to the plant recognition model being unable to provide the answer text about recognizing the plant in the plant images, accessing an external plant knowledge base to obtain additional information about the plant images and the question text, and:
in response to the additional information comprising additional images, providing image features extracted from the additional images using the first visual model to the multimodal large language model, and/or
in response to the additional information comprising additional text, providing the additional text to the multimodal large language model; and
outputting new answer text provided by the plant recognition model about recognizing the plant in the plant images.

21. The plant recognition method according to claim 2, further comprising:
in response to the plant recognition model being unable to provide the answer text about recognizing the plant in the plant images, accessing an external plant knowledge base to obtain additional information about the plant images and the question text, and:
in response to the additional information comprising additional images, providing image features extracted from the additional images using the first visual model and the second visual model respectively to the multimodal large language model, and/or
in response to the additional information comprising additional text, providing the additional text to the multimodal large language model; and
outputting new answer text provided by the plant recognition model about recognizing the plant in the plant images.

22. An electronic device, comprising:
one or more processors; and
a memory storing computer executable instructions, wherein the computer executable instructions, when executed by the one or more processors, enable the one or more processors to execute the plant recognition method according to claim 1.

23. A non-transitory storage medium storing computer executable instructions, wherein the computer executable instructions, when executed by a computer, enable the computer to execute the plant recognition method according to claim 1.

24. A computer program product, the computer program product comprising instructions, wherein the instructions, when executed by a processor, implement the plant recognition method according to claim 1.
